(19) United States
(12) Patent Application Publication
(10) Pub. No.: US 2021/0300212 A1
(43) Pub. Date: Sep. 30, 2021

(54) VEHICLE

(71) Applicant: HONDA MOTOR CO., LTD., Tokyo (JP)

(72) Inventors: Tomohiro ITO, Wako-shi (JP); Kei KOBAYASHI, Wako-shi (JP); Kotone NAKAO, Wako-shi (JP); Mai NUMAZAWA, Wako-shi (JP); Kazutaka NAKABE, Wako-shi (JP)

(73) Assignee: HONDA MOTOR CO., LTD., Tokyo (JP)

(21) Appl. No.: 17/212,443

(22) Filed: Mar. 25, 2021

(30) Foreign Application Priority Data
Mar. 30, 2020 (JP) 2020-060451

(51) Int. Cl. B60N 2/01; B60N 2/14

(52) U.S. Cl. CPC B60N 2/012; B60N 2002/0055; B60N 2/14

(57) ABSTRACT

A vehicle includes: a front seat that is arranged to face rearward in a travel direction; and a rear seat that is arranged, at a rear side of the front seat, to face frontward in the travel direction. At least part of a floor below the front seat is constituted of a flat floor part. A seat portion of the front seat is capable of being flipped up such that a vehicle front side of the seat is a fulcrum point.

### CROSS-REFERENCE TO RELATED APPLICATION

Priority is claimed on Japanese Patent Application No. 2020-060451, filed on Mar. 30, 2020, the contents of which are incorporated herein by reference.

### BACKGROUND

### Field of the Invention

The present invention relates to a vehicle including a plurality of seats in a passenger compartment.

### Background

In recent years, structures of a passenger compartment of a vehicle capable of arranging a plurality of seats in a face-to-face state are known (for example, refer to Japanese Unexamined Patent Application, First Publication No. 2018-62277).

In the vehicle described in Japanese Unexamined Patent Application, First Publication No. 2018-62277, a passenger seat is arranged in three rows behind a driver seat, and a seat in the center row can be used as a table, and the seating direction of a seat in the front row can be switched between a frontward direction and a rearward direction. When the seat in the center row is switched to the table and the seating direction of the seat in the front row is switched to the rearward direction, it is possible to use the seat in the front row (hereinafter, referred to as a “front seat”) and the seat in the rearmost row (hereinafter, referred to as a “rear seat”) in the face-to-face state.

### SUMMARY

In the above vehicle, by switching the seating direction of the front seat to the rearward direction, it is possible to use the front seat and the rear seat in the face-to-face state. However, in the above vehicle, when an occupant brings a load into the passenger compartment, a space for placing the load is occupied by the front seat, and a large load cannot be placed near an occupant seated on the rear seat. Therefore, it is desired that a large load can be placed near the occupant seated on the rear seat.

An aspect of the present invention provides a vehicle that is able to place a large load near an occupant who is in seated on a rear seat.

A vehicle according to an aspect of the present invention includes: a front seat that is arranged to face rearward in a travel direction; and a rear seat that is arranged, at a rear side of the front seat, to face frontward in the travel direction, wherein at least part of a floor below the front seat is constituted of a flat floor part, and a seat portion of the front seat is capable of being flipped up such that a vehicle front side of the seat is a fulcrum point.

According to the configuration described above, when a plurality of occupants are on board in the passenger compartment, the occupants can be seated on the front seat and the rear seat in the face-to-face state. Further, by flipping up the seat portion of the front seat, the flat floor part appears below the seat that is flipped up. An occupant can place a large load on the flat floor part.

The floor part may be formed to be flat between a foot area of the rear seat and a portion of the floor part below the front seat.

In this case, by flipping up the seat portion of the front seat, a large floor part that extends from the foot area of the rear seat to the part below the front seat appears. Therefore, it is possible for the occupant to stably place a large load on the large floor part.

The front seat and the rear seat may have an equal number of seat portions.

In this case, it is possible for a plurality of occupants to be efficiently seated in the face-to-face state.

The front seat may be constituted of a side-by-side seat in which a plurality of seats are laterally aligned in one row side-by-side, and the rear seat may be constituted of independent seats in which adjacent seats are capable of being offset from each other in a vehicle front-to-rear direction.

In this case, by flipping up the seat portion of the front seat, it is possible to efficiently generate a large space in front of the rear seat. Further, since the rear seat is an independent seat capable of being offset in the vehicle front-to-rear direction, even when a plurality of occupants are seated on the rear seat, upper bodies of the occupants seated adjacent to each other are less likely to come into contact with each other.

The height of the lowest end part of a seat surface of the rear seat may be higher than the height of the lowest end part of a seat surface of the front seat.

In this case, when occupants are seated on the front seat and the rear seat in the face-to-face state, a visual line height of an occupant seated on the front seat and a visual line height of an occupant seated on the rear seat are different from each other. Therefore, the occupants seated to face each other tend not to worry about the visual line of another occupant. Further, since the visual line height of the occupant seated on the rear seat is higher relative to the occupant seated on the front seat, a front sight of the occupant seated on the rear seat is improved.

Further, the occupant seated on the front seat and facing rearward tends to be susceptible to motion sickness due to shaking at the time of traveling of the vehicle. However, in the present configuration, since the height of the lowest end part of the seat surface of the front seat is set to be low, the occupant seated on the front seat and facing rearward is strongly pressed against a backrest, and the shaking of the body at the time of traveling of the vehicle is prevented. Accordingly, in a case where the present configuration is employed, it is possible to prevent the motion sickness of the occupant seated on the front seat.

A side window may be arranged on a vehicle body side portion from a side position of the rear seat to a side position of the front seat, and a glass having a dark color shielding part having dots which become gradually sparse toward an upward direction from a lower end may be attached to the side window.

In this case, since the dark color shielding part is arranged in a lower end region of the glass attached to the side window, it is possible to prevent an adjacent object such as a guardrail in a lateral direction of the traveling vehicle from entering the sight of the occupant. Specifically, in the present configuration, since the dots of the dark color shielding part are provided such that the dots become gradually sparse toward the upward direction from the lower end of the glass, the boundary between the dark color shielding part and the scenery of the vehicle outside seen at the upper side of the dark color shielding part is naturally blurred, and uncomfortable feeling is not given to the occupant. Accordingly, in a case where the present configuration is employed, the occupants seated on the front seat and the rear seat can comfortably view the scenery of the vehicle outside through the side window.

An arrangement range in a vertical direction of the dark color shielding part in the glass may be set in accordance with a height of a seat surface of the rear seat and a height of a seat surface of the front seat that are arranged at a side of the dark color shielding part.

In this case, since the arrangement range in the vertical direction of the dark color shielding part is set in accordance with the visual line height of the occupant at the front seat and the rear seat, the adjacent object can be preferably hidden from the sight of the occupant seated on each seat.

According to the aspect of the present invention, by flipping up the seat portion of the front seat, a flat floor part appears below the seat, and therefore, it is possible to place a large load near an occupant who is in seated on the rear seat.

### BRIEF DESCRIPTION OF THE DRAWINGS

FIG. 1 is a schematic side view showing an inside of a vehicle according to an embodiment.

FIG. 2 is a schematic top view showing the inside of the vehicle according to the embodiment.

FIG. 3 is a schematic side view showing the inside of the vehicle according to the embodiment.

FIG. 4 is a perspective view showing a rear seat and the vicinity of the rear seat of the vehicle according to the embodiment.

FIG. 5 is a perspective view showing the rear seat and the vicinity of the rear seat of the vehicle according to the embodiment.

FIG. 6 is a side view showing a glass attached to a side window according to the embodiment.

FIG. 7 is a view showing a state in which the vehicle outside is seen via the glass according to the embodiment.

FIG. 8 is a front view of the vehicle schematically showing a condition when the vehicle outside is seen via the glass according to the embodiment.

### DESCRIPTION OF EMBODIMENTS

Hereinafter, an embodiment of the present invention will be described with reference to the drawings. In the drawings, an arrow FR that indicates a front side of a vehicle 1, an arrow UP that indicates an upward direction of the vehicle 1, and an arrow LH that indicates a left-hand side of the vehicle 1 are shown.

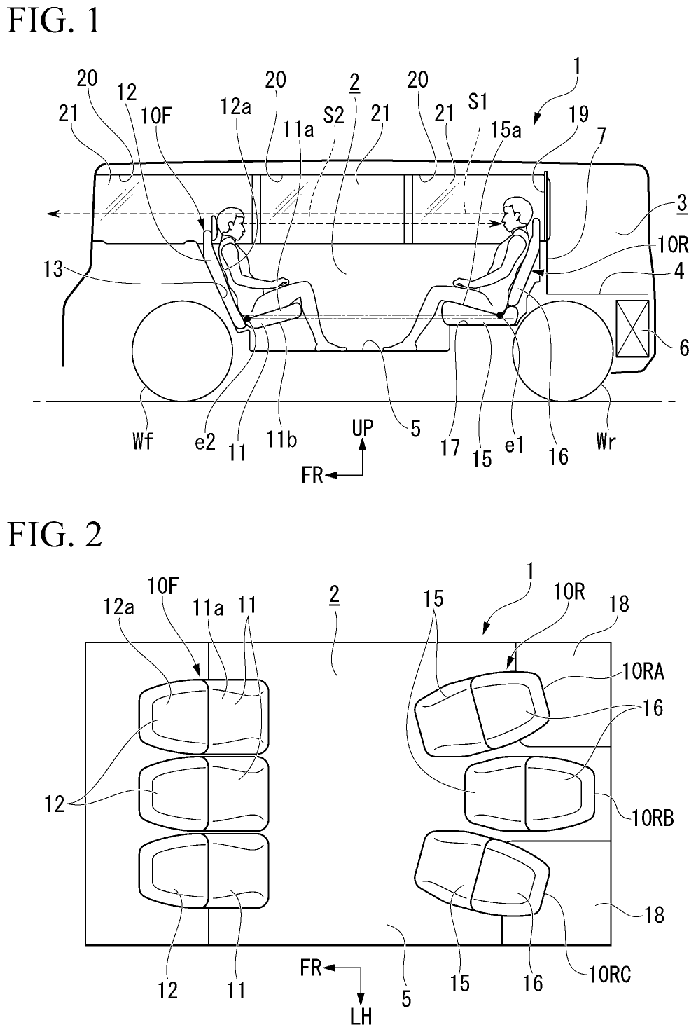

FIG. 1 is a side view of the vehicle 1 of the embodiment schematically showing a vehicle inside. FIG. 2 is a top view of the vehicle 1 of the embodiment schematically showing the vehicle inside.

The vehicle 1 is an automated driving vehicle capable of unmanned traveling, and a passenger compartment 2 on which an occupant boards is widely ensured in a middle region in a vehicle front-to-rear direction. Specifically, the passenger compartment 2 extends in the front-to-rear direction from a rear position of a front wheel Wf to the vicinity of a substantially middle position of a rear wheel Wr.

A load room 3 in which a load can be loaded from a vehicle rear side is formed behind the passenger compartment 2. The passenger compartment 2 and the load room 3 are separated by a partition wall 7. A floor part 4 of the load room 3 is set to be higher than a floor part 5 of the passenger compartment 2. The floor part 4 of the load room 3 is arranged at a higher position than the rear wheel Wr. A battery, a control circuit, and the like (drive system device 6, not shown) for driving a motor for driving the vehicle is arranged below the floor part 4 of the load room 3.

A front seat 10F of a side-by-side seat type (bench seat type) in which a plurality of seats 11 are laterally arranged side-by-side in one row is arranged on a front side in the passenger compartment 2. A rear seat 10R of an independent seat type in which adjacent seats are capable of being offset in the vehicle front-to-rear direction is arranged on a rear side in the passenger compartment 2.

The front seat 10F is arranged such that three seats 11 are arranged side-by-side in a lateral direction. A backrest 12 that corresponds to each seat portion 11 of the front seat 10F is fixed to a frame 13 on a vehicle body front side in a state of being inclined frontward at a predetermined angle. Each seat portion 11 of the front seat 10F is capable of being flipped upward such that a front end side of the seat portion 11 is a rotation fulcrum point. The number of seats 11 of the front seat 10F may be two or more and is not limited to three.

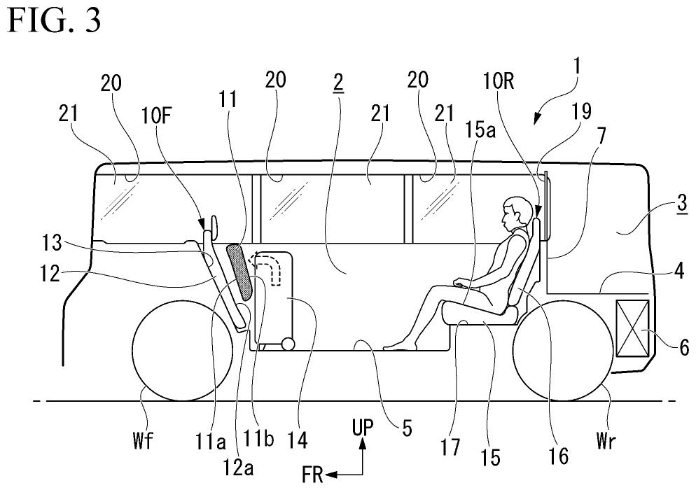

FIG. 3 is a side view of the vehicle 1 similar to FIG. 1 showing a state where the seat portion 11 of the front seat 10F is flipped upward.

In a state where each seat portion 11 of the front seat 10F is flipped upward, a seat surface 11a faces a backrest surface 12a of the backrest 12, and a rear surface 11b is directed toward the rear seat 10R side (vehicle rear side) in a state of being inclined upward toward the vehicle rear side. The floor part 5 of the passenger compartment 2 is constituted of a flat surface that extends from the vicinity of a front part of the rear seat 10R to a lower position of the backrest 12 of the front seat 10F. Therefore, as shown in FIG. 3, it is possible to arrange a large load 14 such as a suitcase in a space above the floor part 5 that is formed when the seat portion 11 of the front seat 10F is flipped up.

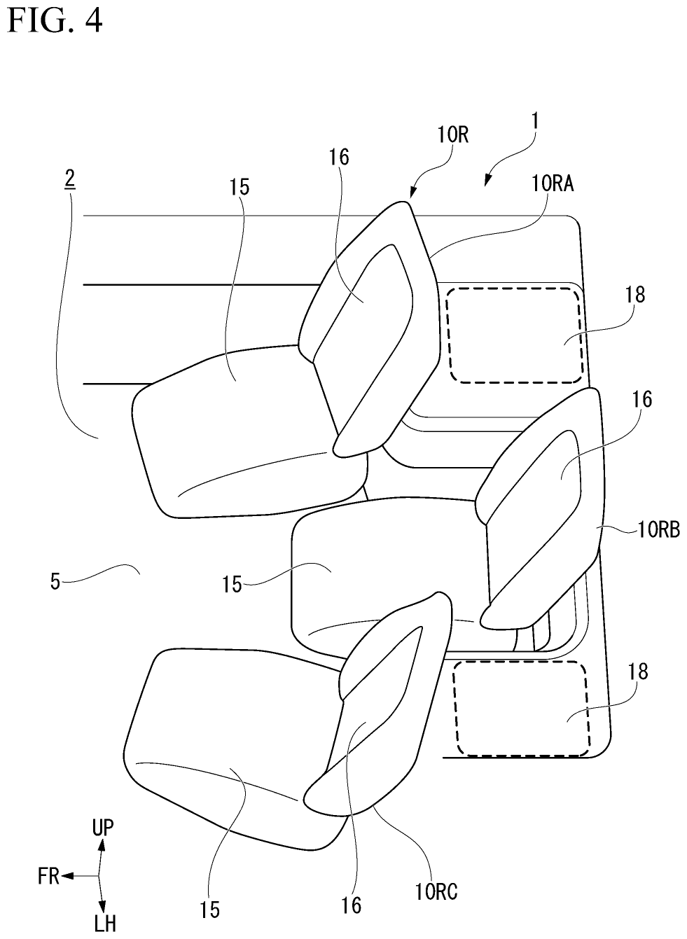

FIG. 4 is a perspective view showing the rear seat 10R in the passenger compartment 2.

In the rear seat 10R, three seat blocks 10RA, 10RB, and 10RC each constituted of a pair of the seat portion 15 and the backrest 16 are arranged to be spaced apart from each other in a vehicle width direction. In the two seat blocks 10RA and 10RC arranged at the outside in the vehicle width direction, each seat portion 15 is arranged to be inclined inward in the vehicle width direction relative to the vehicle frontward direction. The seat block 10RB at the middle in the vehicle width direction is arranged to face straight in the vehicle frontward direction. Further, the seat block 10RB at the center in the vehicle width direction is arranged to be offset to the vehicle rear side relative to the two seat blocks 10RA and 10RC at the outside in the vehicle width direction.

In the present embodiment, the three seat blocks 10RA, 10RB, and 10RC are provided to be fixed to a frame 17 in the vehicle room. However, each block 10RA, 10RB, and 10RC may be movably arranged on the floor part 5 via a seat rail or the like.

Further, an article storage part 18 is arranged at a rearward position of each of the two seat blocks 10RA and 10RC at the outside in the vehicle width direction in the passenger compartment 2. It is possible for the article storage part 18 to store an article inside the article storage part 18, and it is also possible to place an article on an upper surface side of the article storage part 18.

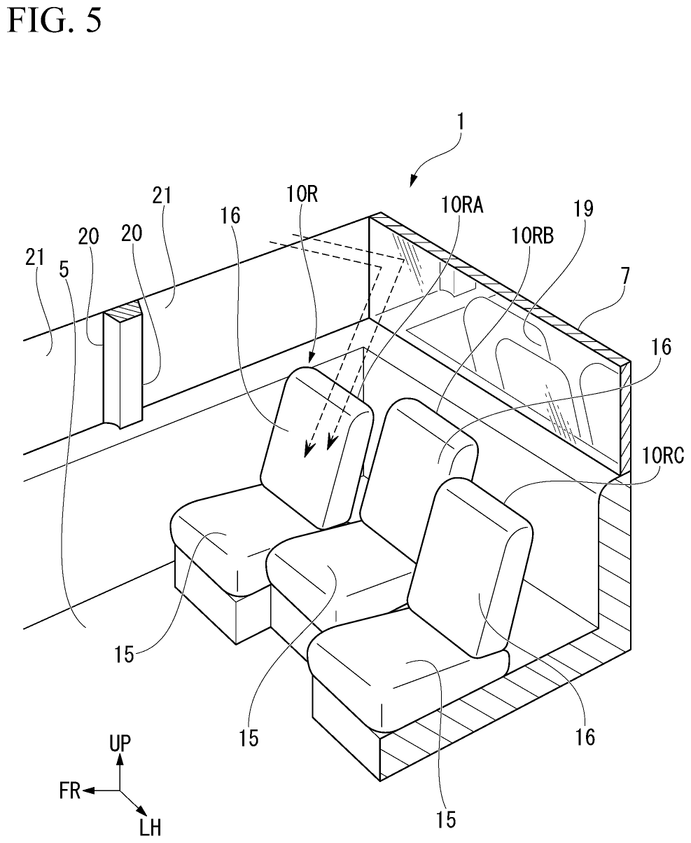

FIG. 5 is a perspective view showing the rear seat 10R and an area behind the rear seat 10R in the passenger compartment 2.

As shown in FIG. 1, FIG. 3, and FIG. 5, a mirror body 19 that reflects the vehicle front side is attached to a front surface (a plane that faces the vehicle front side) of the partition wall 7 that partitions the passenger compartment 2 and the load room 3. The mirror body 19 is arranged behind the backrest 16 of the rear seat 10R. The mirror body 19 is arranged to be continuous from one end side to another end side in the vehicle width direction.

A side window 20 through which a vehicle outside is capable of being viewed is arranged on a vehicle body side portion. In the present embodiment, three side windows 20 are arranged from a side position of the rear seat 10R to a vehicle front end part.

A glass 21 is attached to each side window 20. The glass 21 attached to the side window 20 is not necessarily limited to a glass that consists of a glass material and also includes a transparent resin or the like having a light transmission property. Further, the number of side windows 20 arranged on the vehicle body side portion is not limited to three and may be an arbitrary number. Further, a range in which the side window 20 is arranged is not limited to the range described above, and the side window 20 may be arranged on at least the vehicle body side portion at a side of the rear seat 10R. However, it is desirable that the range in which the side window 20 is arranged is a range from the side position of the rear seat 10R to the side position of the front seat 10F of the vehicle body side portion.

Here, the mirror body 19 attached to the partition wall 7 in the passenger compartment 2 is provided such that the height of an end part is equal to or less than the height of a lower end part of the side window 20, and the height of an upper end part is set to be equal to or more than the height of an upper end of the side window 20. Therefore, in the vehicle of the present embodiment, it is possible to favorably reflect the external scenery or the external light on the mirror body 19 through the side window 20.

Further, as shown in FIG. 1, the height of the lowest end part e1 of a seat surface 15a of the rear seat 10R provided in the passenger compartment 2 is set to be higher than the lowest end part e2 of the seat surface 11a of the front seat 10F. Therefore, when occupants are seated on the front seat 10F and the rear seat 10R in the face-to-face state, the visual line height of the occupant seated on the rear seat 10R is higher relative to (the visual line height of) the occupant seated on the front seat 10F.

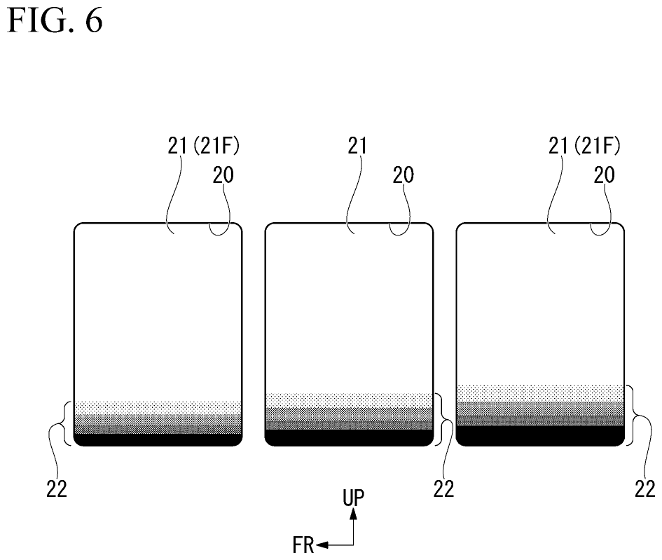

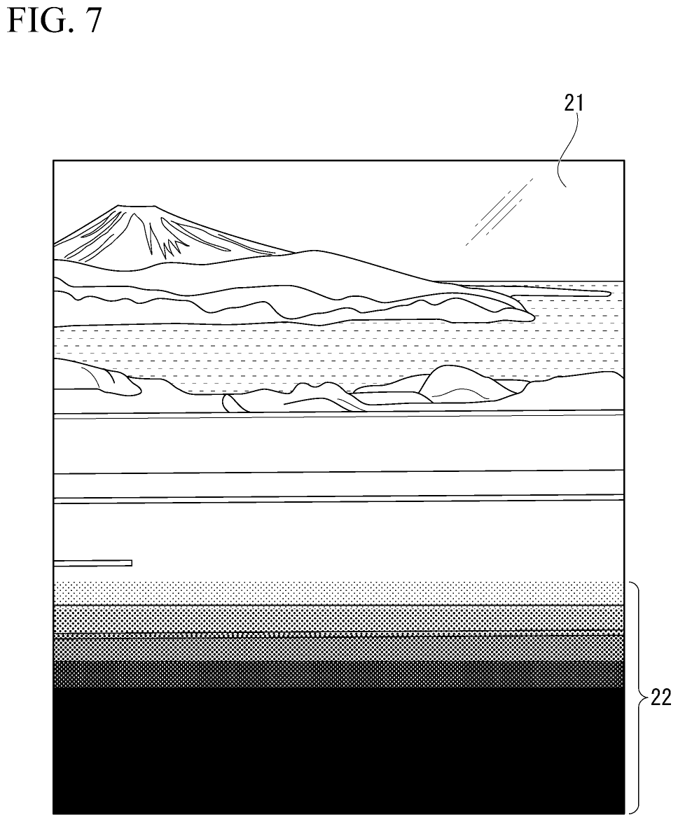

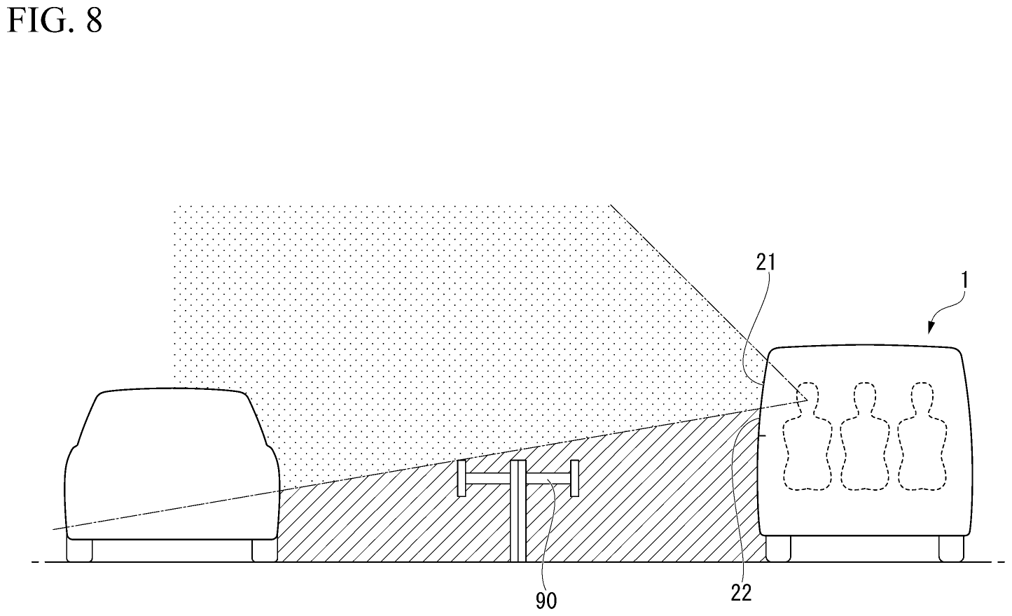

FIG. 6 is a side view showing the glass 21 attached to the three side windows 20 at the vehicle body side portion. FIG. 7 is a view showing a condition when the vehicle outside is seen through the glass 21. FIG. 8 is a front view of the vehicle 1 schematically showing a condition when the vehicle outside is seen through the glass 21.

A black ceramics 22 which is one form of a dark color shielding part is attached to a lower end region of each glass 21. As shown in FIG. 6 and FIG. 7, the black ceramics 22 is attached in a dot form in a predetermined range in the vertical direction at a lower end of the glass 21. Dots of the black ceramics 22 are attached such that the dots become gradually sparse toward the upward direction from the lower end of the glass 21. The black ceramics 22 can prevent an adjacent object 90 (refer to FIG. 8) such as a guardrail at the side of the traveling vehicle from entering the sight of the occupant. Further, since in the black ceramics 22, the dots are provided such that the dots become gradually sparse toward the upward direction from the lower end, it is possible to naturally blur the boundary between the black ceramics 22 and the scenery outside the vehicle that is seen at the upper side of the black ceramics 22.

In the present embodiment, the black ceramics 22 is employed as one form of the dark color shielding part. However, the dark color shielding part may be a material other than the black ceramics 22 as long as the dark color shielding part is a material that is dark and that can shield the external light.

Further, the arrangement range in the vertical direction of the black ceramics 22 in the glass 21 is set in accordance with the height of the seat surface 15a of the rear seat 10R and the height of the seat surface 11a of the front seat 10F arranged at a side of the glass 21. Specifically, as shown in FIG. 6, in the glass 21 (21R) arranged at the side of the rear seat 10R of which the height of the seat surface 15a is high, the range in the vertical direction in which the black ceramics 22 is arranged is widened compared to the glass 21 (21F) arranged at the side of the front seat 10F.

As described above, in the vehicle 1 of the present embodiment, part of the floor below the front seat 10F is constituted of the flat floor part 5, and the seat portion 11 of the front seat 10F is capable of being flipped up such that the vehicle front side of the seat portion 11 is a fulcrum point. Therefore, by flipping up the seat portion 11 of the front seat 10F, the flat floor part 5 appears below the seat portion 11, and it becomes possible to place a large load 14 near an occupant seated on the rear seat 10R.

Specifically, in the vehicle 1 of the present embodiment, a region between the foot area of the rear seat 10R and part of the floor below the front seat 10F is constituted of a flat floor part 5. Therefore, by flipping up the seat portion 11 of the front seat 10F, a large floor part 5 that extends from the foot area of the rear seat 10R to the part of the floor below the front seat 10F appears. Accordingly, in a case where the present configuration is employed, it becomes possible for the occupant to stably place a large load 14 on the large floor part 5.

Further, in the vehicle 1 of the present embodiment, since the front seat 10F and the rear seat 10R have the same number of seats 11 and 15, a plurality of occupants can be efficiently seated in the face-to-face state.

Further, in the vehicle 1 of the present embodiment, the front seat 10F is constituted of a side-by-side seat (bench seat), and the rear seat 10R is constituted of independent seats in which adjacent seats are offset from each other in the vehicle front-to-rear direction. Therefore, by flipping up the seat portion 11 of the front seat 10F, it is possible to efficiently generate a large space in front of the rear seat 10R. Further, since the rear seat 10R is an independent seat capable of being offset in the vehicle front-to-rear direction, even when a plurality of occupants are seated on the rear seat 10R, upper bodies of the occupants seated adjacent to each other are less likely to come into contact with each other. Accordingly, in a case where the configuration of the present embodiment is employed, it is possible to further enhance the comfort of the occupant in the passenger compartment 2.

Further, in the vehicle 1 of the present embodiment, the height of the lowest end part e1 of the seat surface 15a of the rear seat 10R is set to be higher than the height of the lowest end part e2 of the seat surface 11a of the front seat 10F. Therefore, when occupants are seated on the front seat 10F and the rear seat 10R in the face-to-face state, the height of the visual line s1 of an occupant seated on the rear seat becomes higher than the height of the visual line s2 of an occupant seated on the front seat 10F. Accordingly, in a case where the present configuration is employed, the occupants seated to face each other tend not to worry about the visual line of another occupant. Further, since the height of the visual line s1 of the occupant seated on the rear seat 10R becomes higher relative to the upper body of the occupant seated on the front seat 10F, the front sight of the occupant seated on the rear seat 10R is improved.

Further, in the vehicle 1 of the present embodiment, since the height of the lowest end part e2 of the seat surface 11a of the front seat 10R is set to be low, the occupant seated on the front seat 10F and facing rearward is strongly pressed against the backrest 12, and the shaking of the body at the time of traveling of the vehicle is prevented. Accordingly, in a case where the vehicle 1 of the present embodiment is employed, it is possible to prevent the motion sickness of the occupant seated on the front seat 10F.

Further, in the vehicle 1 of the present embodiment, the black ceramics 22 are attached to the glass 21 of the side window 20 such that dots become gradually sparse toward the upward direction from the lower end. Therefore, at the time of traveling of the vehicle, it is possible to prevent an adjacent object 90 such as a guardrail in a lateral direction of the vehicle from entering the sight of the occupant in the passenger compartment 2. Specifically, in the present embodiment, since the dots of the black ceramics 22 are provided such that the dots become gradually sparse toward the upward direction from the lower end of the glass 21, the boundary between the black ceramics 22 and the scenery of the vehicle outside seen at the upper side of the black ceramics 22 is naturally blurred, and uncomfortable feeling is not given to the occupant. Accordingly, in a case where the present configuration is employed, the occupants seated on the front seat 10F and the rear seat 10R can comfortably view the scenery of the vehicle outside through the side window 20.

Further, in the vehicle 1 of the present embodiment, the arrangement range in the vertical direction of the black ceramics 22 in the glass is set in accordance with the height of the seat surface 15a of the rear seat 10R and the height of the seat surface 11a of the front seat 10F that are arranged at a side of the black ceramics 22. Therefore, the adjacent object 90 can be preferably hidden from the sight of the occupant seated on each seat.

The present invention is not limited to the embodiment described above, and various design changes can be made without departing from the scope of the invention.

What is claimed is:

1. A vehicle, comprising:
a front seat that is arranged to face rearward in a travel direction; and
a rear seat that is arranged, at a rear side of the front seat, to face frontward in the travel direction,
wherein at least part of a floor below the front seat is constituted of a flat floor part, and
a seat portion of the front seat is capable of being flipped up such that a vehicle front side of the seat is a fulcrum point.

2. The vehicle according to claim 1,
wherein the floor part is formed to be flat between a foot area of the rear seat and a portion of the floor part below the front seat.

3. The vehicle according to claim 1,
wherein the front seat and the rear seat have an equal number of seat portions.

4. The vehicle according to claim 3,
wherein the front seat is constituted of a side-by-side seat in which a plurality of seats are laterally aligned side-by-side in one row, and
the rear seat is constituted of independent seats in which adjacent seats are capable of being arranged to be offset from each other in a vehicle front-to-rear direction.

5. The vehicle according to claim 1,
wherein a height of the lowest end part of a seat surface of the rear seat is higher than a height of the lowest end part of a seat surface of the front seat.

6. The vehicle according to claim 1,
wherein a side window is arranged on a vehicle body side portion from a side position of the rear seat to a side position of the front seat, and
a glass having a dark color shielding part having dots which become gradually sparse toward an upward direction from a lower end is attached to the side window.

7. The vehicle according to claim 6,
wherein an arrangement range in a vertical direction of the dark color shielding part in the glass is set in accordance with a height of a seat surface of the rear seat and a height of a seat surface of the front seat that are arranged at a side of the dark color shielding part.
